(19) United States
(12) Patent Application Publication
(10) Pub. No.: US 2013/0201712 A1
(43) Pub. Date: Aug. 8, 2013

(54) MOTOR VEHICLE LIGHTING DEVICE

(71) Applicants: Kamislav Fadel, Stuttgart (DE); Michael Hamm, Eningen u.A. (DE); Wolfgang Hoßfeld, Gomaringen (DE); Christian Buchberger, Reutlingen (DE)

(72) Inventors: Kamislav Fadel, Stuttgart (DE); Michael Hamm, Eningen u.A. (DE); Wolfgang Hoßfeld, Gomaringen (DE); Christian Buchberger, Reutlingen (DE)

(21) Appl. No.: 13/570,466

(22) Filed: Aug. 9, 2012

(30) Foreign Application Priority Data
Aug. 17, 2011 (DE) 10 2011 081 077.3

(51) Int. Cl. F21S 8/10

(52) U.S. Cl. CPC F21S 48/115; F21S 48/12
USPC 362/516

(57) ABSTRACT

A headlight for a motor vehicle composes at least two semiconductor-light sources and a plurality of light refractors and/or reflecting optics. Light of each of the semiconductor-light sources is directed into a front area of the headlight such that the light produces at the front area a rule-consistent light distribution. An illuminated section of the light distribution of a first of the semiconductor-light sources is not identical with an illuminated section of a second of the semiconductor-light sources. The first semiconductor-light source defines a first construction type and the second semiconductor-light source defines a second construction type. The first construction type defines higher luminous flux and lower efficiency relative to luminous flux and efficiency defined by the second construction type.

### CROSS REFERENCE TO RELATED APPLICATION

This application claims priority to and benefit of the filing date of German Patent Application 10 2011 081 0773 filed on Aug. 17, 2011.

### BACKGROUND OF INVENTION

1. Field of Invention

The present invention is directed toward a lighting device and, more specifically, to a headlight for a motor vehicle.

2. Description of Related Art

Such a headlight is known from EP 1 357 332 A2. With lighting equipment for motor vehicles, there is a basic distinction between lights and headlights. Lights serve the purpose of indicating to other traffic participants the presence and/or behavior of a motor vehicle and/or intentions of its driver. Examples of lights are brake lights, indicator lights, and position lights.

However, headlights serve the purpose of actively illuminating the driving path of a motor vehicle in such a way that the driver may notice obstacles early enough. The light distributions have to be rule-consistent to make sure that, for example, other traffic participants are not blinded. Examples of light distributions produced by headlights are low-beam and high-beam light distributions.

The purpose and ability of a unit producing light distributions (be it signal light distributions or headlight distributions) is light function. With respect to a light distribution mainly functioning as a headlight, its main functions can be distinguished from other light functions that arc provided by the same lighting equipment when these, for example, also fulfill “signal light” functions.

With road motor vehicles produced in series, semiconductor-light sources are only used for headlight main functions since 2008 while they have been introduced for “signal light” functions even earlier. One reason for this delay resulted from the higher light-energy demand for these main functions in comparison to “signal” functions.

To produce the high luminous flux necessary for the main functions, light-emitting diodes are used for semiconductor-light sources that are delivered pre-assembled on a carrier and produce comparatively high luminous fluxes with comparatively high electrical currents. While light-producing filaments from light bulbs or electric ares front gas-discharge lamps in use are getting very hot (within a range of 2×10³ degrees to 3×10³ degrees) and, thus, emit comparatively much heat along with the visible light, semiconductor-light sources are emitting their light at much lower temperatures (within a range of 1×10² degrees to less than 2×10² degrees). Semiconductor-light sources can be realized as a single emitter or also as an array of single emitters summarized to a composite structure.

The electric energy being converted into heat during the use of the semiconductor-light source occurs within the chip of the semiconductor-light source and has to he discharged by cooling elements since, otherwise, the chip would be destroyed from overheating. Efficient cooling elements are large, heavy, and expensive, which is to be counted as a disadvantage in any case. For reasons of limited space, there is an interest in compact headlights. Heaviness is counterproductive in view of the desired weight reduction of motor vehicles, and higher costs are always disadvantageous.

In this context there is an interest to produce light distributions for main functions of headlights with high efficiency. The efficiency meant here concerns the electric power standardised for the luminous flux of a semiconductor-light source. This is to be still differentiated from m optical efficiency, which can be defined as the standardized luminous-flux portion, of the produced luminous flux, which actually amounts to the desired light distribution.

In this connection, EP 1 357 332 A2 concerns an optical efficiency and shows a relatively compactly constructed light module for a motor-vehicle headlight, whereby the light module is made of a semiconductor-light source in a form of a light-emitting diode arranged on an optical axis of the light module. Light of the light-emitting diode is mainly emitted orthogonally toward the optical axis of the tight module and thereafter focused by a primary optics made-up as a half-cup-shaped reflector on an edge of a mirrored panel arranged horizontally and on the level of the optical axis of the motor vehicle.

Light propagating directly past the edge as well as light reflecting at the mirrored panel is bundled by a secondary optics made-up of a projector lens and projected into the front area of the headlight. Hereby, a light distribution with a sharp cut-off line is being produced in the front area of the headlight, which results from the projection of the panel edge. By use of the mirrored and horizontally positioned panel, a high optical efficiency is achieved since the light not needed in the darker area of the resulting light distribution is not merely cut off, but directed toward the secondary lens and, from there, into the light area by the position and reflection of the panel.

Generally, in regard to headlight main functions, even when there is high optical efficiency that, produce high luminous fluxes, there is a need for semiconductor-light sources. To produce a maximum luminous flux with a given light-emitting diode as a semiconductor-light source, it is principally possible to operate it at an unfavorable working point in regard to energy efficiency for that light-emitting diode, which is close to the maximum electric current of the light-emitting diode. Hereby, comparatively much heat is produced, which has to be discharged. If a working point is chosen that is more favorable in view of the efficiency, then the luminous flax is reduced. To achieve the total necessary luminous flux, several separate light modules can be used, which, on the other hand, would lead to a less compact solution. This course is followed in EP 1 357 332 A2.

It is assumed that putting the focus on optimizing the energy efficiency of a headlight equipped with a certain, amount of semiconductor-light sources goes hand in hand with unwanted restrictions, which will affect the quality of the light distribution in a direct or indirect way. Such unwanted restrictions could be, e.g., the flexibility or possibility to fulfill special requirements.

Thus, there is a need in the related art for a motor-vehicle headlight with which it is possible to achieve high-energy efficiency without having to deal with major restrictions.

### SUMMARY OF INVENTION

The invention overcomes disadvantages in the related art in a headlight for a motor vehicle. The headlight comprises at least two semiconductor-light sources and a plurality of light refractors and/or reflecting optics. Light of each of the semiconductor-light sources is directed into a front area of the headlight such that the light produces at the front area a rule-consistent light distribution. An illuminated section of the light distribution of a first of the semiconductor-light sources is not identical with an illuminated section of a second of the semiconductor-light sources. The first semiconductor-light source defines a first construction type and the second semiconductor-light source defines a second construction type. The first construction type defines higher luminous flux and lower efficiency relative to luminous flux and efficiency defined by the second construction type.

The invention differs from the related art in that a first of the at least two semiconductor-light sources is made-up of a first construction type and a second of the semiconductor-light sources is made-up of a second construction type, whereby the first and second construction types differ in that their semiconductor-light sources have different luminous fluxes and efficiency. More specifically, the semiconductor-light sources of the first construction-type have higher luminous flux and lower efficiency in comparison with those of the semiconductor-light sources of the second construction type (on the other hand, the semiconductor-light sources of the second construction type have higher efficiency and lower luminous flux in comparison with those of the semiconductor-light sources of the second construction type).

One section being illuminated by the first semiconductor-light source of the light distribution and not identical with the section being illuminated by the second semiconductor-light source of the light distribution results in the possibility that a semiconductor-light source for illuminating a certain section can be chosen with special consideration of the luminous flux demands for that section. This advantage is real feed in that the lesser efficient and rather high luminous-flux-emitting first semiconductor-light sources are only used for sections with a comparatively high demand of luminous flux while the more efficient second semiconductor-light sources can be used for sections with a comparatively lower demand of luminous flux.

In an embodiment, with sections having different demands of luminous flux, those sections with higher demands of luminous flux are illuminated by high luminous-flux-emitting semiconductor-light sources, and those sections with lower demands of luminous flux are illuminated by semiconductor-light sources having higher efficiency.

In an embodiment, for all semiconductor-light sources of one light module, one common cooling element is used.

In an embodiment, the individual optical lenses are part of a single-piece optical-lens carrier.

In an embodiment, the optics for each of the at least two light sources has an optical lens and a common secondary lens for several semiconductor-light sources, whereby, in any case, the optical lenses are arranged in such a way that they focus the light of a semiconductor-light source and direct it onto the secondary lens directly or indirectly and the secondary lens is arranged in such a way that incoming light is directed into the front area of the headlight.

In an embodiment, the optical lenses are light-focusing TIR-optics or ancillary lenses. In an embodiment, the optics consists of a panel. In an embodiment, the panel is a mirrored panel that is designed and arranged to reflect incoming light of the semiconductor-light sources on the mirrored area toward the secondary lens.

In an embodiment, the light distribution in the front area of the headlight consists of a central section and peripheral sections surrounding the central section, whereby the central section is illuminated by at least one of the semiconductor-light sources of the first construction type.

In an embodiment, at least one of the peripheral sections is illuminated by at least one of the semiconductor-light sources of the second construction type.

In an embodiment, the light distribution consists of peripheral sections, a left-side illuminating area, a left front-section area, a central front-section area, a right front-section area, a right-side illuminating area, a central maximum area, and a central gradient area of an asymmetrical light distribution.

In an embodiment, each of the left-side illuminating area, right-side illuminating area, and central maximum area is illuminated with two semiconductor-light sources, while each of the remaining sections and areas is illuminated with one semiconductor-light source. In an embodiment, the central maximum area is illuminated by two semiconductor-light sources of the first construction type. In an embodiment, the left-side illuminating area and right-side illuminating area are illuminated by two semiconductor-light sources of the second construction type or one semiconductor-light source of the first construction type and one semiconductor-light source of the second construction type, respectively. In an embodiment, the central gradient area of the asymmetrical light distribution is illuminated by a semiconductor-light source of the first construction type.

Other objects, features, and advantages of the invention are readily appreciated as it becomes more understood while the subsequent detailed description of at least one embodiment of the invention is read taken in conjunction with the accompanying drawing thereof.

### BRIEF DESCRIPTION OF EACH FIGURE OF DRAWING OF INVENTION

FIG. 1 shows an embodiment of a headlight of a motor vehicle according to the invention;

FIG. 2 shows perspectively an arrangement of “n” semiconductor-light sources on a circuit board with corresponding optical lenses and a cooling element;

FIG. 3 shows several sections of a light distribution of the headlight;

FIG. 4 shows diagrammatically value pairs of luminous flux and efficiency for three different construction types of semiconductor-light sources;

FIG. 5 shows an example of an arrangement of a total of “N” semiconductor-light sources of a first construction type and second construction type;

FIG. 6 shows an example of an arrangement of a total of “n” semiconductor-light sources of a first construction type and second construction type; and

FIG. 7 shows an example of an arrangement of a total of “n” semiconductor-light sources of a first construction type, second construction type, and third construction type.

### DETAILED DESCRIPTION OF EMBODIMENTS OF INVENTION

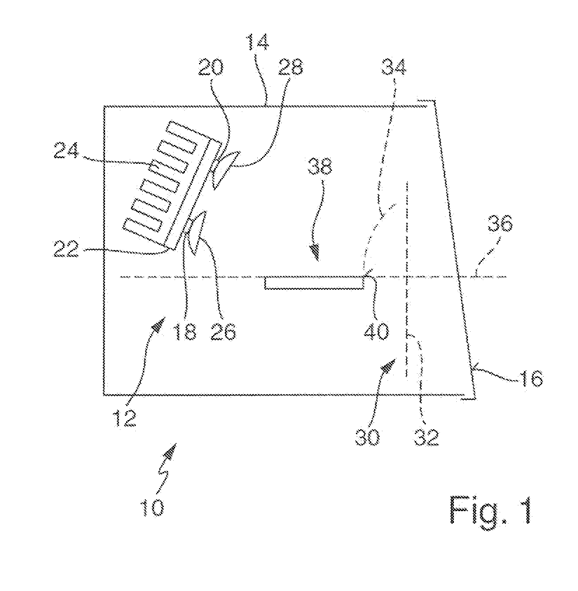

In detail, FIG. 1 displays a headlight 10 for a motor vehicle that consists of at least one light module 12 for producing at least one headlight-light distribution. This at least one headlight-light distribution consists of a light distribution that has a cut-off line (as in the case of a low-beam-light distribution) or does not have a cut-off line (as in the case of a high-beam-light distribution).

The light module 12 is situated inside the housing 14 of the headlight 10 and displays a light aperture that is covered with a translucent cover 16. The light module 12 is made up of a first row 18 and second row 20 of semiconductor-light sources. The semiconductor-light sources of the first row 18 and second row 20 are each arranged in a vertical line in respect to the drawing layer so that only one semiconductor-light source is visible in each row.

The semiconductor-light sources of the first row 18 and second row 20 are arranged on one circuit hoard 22. The semiconductor-light sources of the first row 18 and second row 20 are supplied and controlled with electric energy by electric connections on the circuit hoard 22. For this reason, it is possible to connect the circuit board 22 with the power supply of the motor vehicle—in an embodiment, by a plug connection. In addition to this, the circuit board 22 is connected to a control unit, or the circuit board 22 contains “control” electronics for operating the semiconductor-light sources of the first row 18 and second row 20. In an embodiment, such “control” electronics are to be connected to at least one control unit of the motor vehicle by a bus system to implement a light distribution demanded from the driver or an assistance system.

On the other side of the circuit board 22 and on the opposite side of the semiconductor-light sources of the first row 18 and second row 20, there is a cooling element 24 that absorbs the heat produced by the semiconductor-light sources and their semiconductor material during use and then releases it to the ambient air.

Hereby, in an embodiment, there is only one common cooling element 24 for all semiconductor-light sources of a light module 12. This one is sufficiently large and can absorb enough heat by which local overheating can be prevented effectively. The cooling element 24 is, in an embodiment, made-up of a metal with good heat conductivity—like copper, aluminum, or an alloy containing aluminum or copper.

For each semiconductor-light source of the first row 18 and second row 20, there is an optical lens. Each optical lens is arranged in such a way that it bundles the light coming from a semiconductor-light source and then focuses it into the pre-defined direction. The optical lenses are, thus, arranged in rows, just like the semiconductor-light sources of the first row 18 and second row 20, which are arranged vertical to the drawing layer. A first row 26 of optical lenses is assigned to the first row 18 of semiconductor-light sources while the second row 28 of optical lenses is assigned to the second row 20 of semiconductor-light sources. As a result of the arrangement of the rows. It is possible to see only one optical lens of the first row 26 and one optical lens of the second row 28 in FIG. 1. The optical lenses are, in an embodiment, realized as light-refracting lenses or light-refracting lenses in addition to optical elements that work with a total internal reflection.

With lenses, there is a first refraction that changes the direction of light propagation when light enters the material of the lens. A second change of direction occurs only at the refraction at the light-emitting surface, where light exits the lens. With optical elements that additionally use total internal reflection, another reflection occurs for at least some rays of light between the light entry and emission at the total-reflecting side area of the optical element so that, in this case, those rays that reflect on the side areas change direction at least three times.

Each pair made-up of a semiconductor-light source and its assigned optical lens produces an image of the light-emitting area of the semiconductor-light source in the interior of the headlight 10. An overlapping of the images of the illuminating light-emitting areas of the semiconductor-light sources of the light module 12 results in an inner light distribution on the Interior of the headlight 10.

The light module 12 displays a secondary lens 30, which is arranged at a distance to the internal light distribution in the interior of the headlight 10, that amounts to about the focal length of the secondary lens 30. The secondary lens 30 involves, e.g., a projection lens 32. Basically, reflection variations can also be used as secondary optics. With such an arrangement, the projection lens 32 enlarges and reproduces the inner light distribution into the front area of the headlight—in particular, onto the road in front of the motor vehicle. The optical lenses and secondary lens 30 are, in an embodiment, arranged toward each other in such a way that their inner light distribution is produced in a “Petzval” field curvature of the secondary lens 30 or projection lens 32. The “Petzval” field curvature 34 involves a convex area within the “image” plane of the projector lens that is reproduced by the projector lens 32 into an even light distribution inside the image area of the projection lens, which runs parallel to a main level of the projector lens 32. By a panel 38, which reaches into the inner light distribution and limits the light distribution with a panel edge, it is possible to produce a cut-off line in the light distribution that appears into the front area of the headlight. Hereby, the cut-off line is an image of the panel edge 40 of the panel 38 reaching into the inner light distribution. To influence the light gradient at the cut-off line, at least one section of one side of the projection lens can he equipped with regular or irregular micro-structures. Likewise, it is possible to have structures on the lens for producing overhead values.

Such a panel can be situated vertically toward the optical axis 36. In that case, it would shield off the light reaching its panel area. The shielded light, thus, does not reach the projection lens 32 and contribute to the production of the light distribution In the front area of the headlight. Thus, light gets lost that impairs the optical efficiency of the system.

This can be avoided when, instead of a vertically, a substantially horizontally arranged panel is used with respect to the optical axis 36 that is mirrored on the side facing the semi-section, in which the semiconductor-light sources are located. In the representation of FIG. 1, this is the semi-section above the optical axis 36 and within the headlight housing 24. The part of the light emitted by the semiconductor-light sources that reaches past the panel edge 40 fells directly onto the projection lens 32, which projects it into the front area of the headlight 10.

Also, the part of the light of the semiconductor-light sources that falls into the mirrored side of the panel 38 does not get lost, but is projected by the mirrored side onto the projection lens 32 and, from there, refracted into the light distribution in front of the vehicle. This is also the criteria for the position of the mirrored panel. This one is to be positioned in such a way that the light tailing onto its mirrored side is directed into the illuminated area of the light distribution in the front area of the headlight by the secondary lens. In this way, loss of light is minimized, on the one hand, and it also results in high optical efficiency of the light module 12 or headlight 10. On the other hand, die panel, edge is also displayed as a cut-off line in the front area of die headlight.

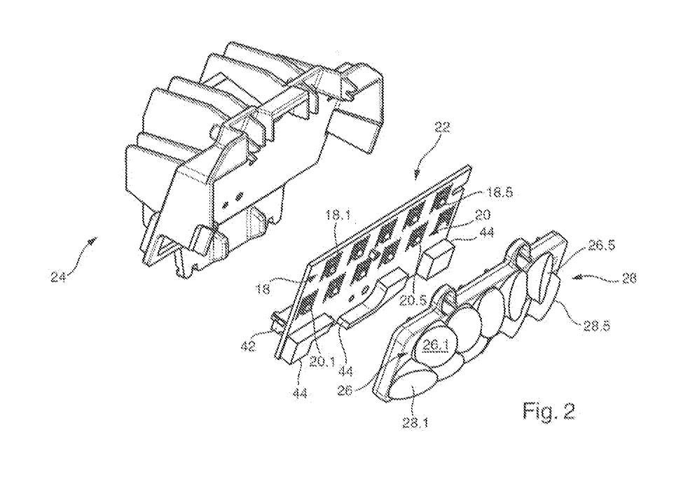

FIG. 2 displays a perspective depiction of an arrangement of “n”=10 semiconductor-light sources with circuit board, optical lenses, and cooling elements. But, it is to be understood that “N” can also have values other than 10. For now, it is only essential that there are at least first and second semiconductor-light sources. The number “N” of semiconductor-light sources could also reach 100.

A first row 18 of semiconductor-light sources displays five semiconductor-light sources 18.1, 18.2, 18.3, 13,4, 18.5. A second row of semiconductor-light sources displays five semiconductor-light sources 20.1, 20,2, 20.3, 20.4, 20,5. Yet, the arrangement does not have to be made into two equal parts, and more than two rows or an irregular arrangement could be used. In the displayed embodiment, these semiconductor-light sources are arranged onto a common circuit board.

Next to the semiconductor-light sources that are displayed in FIG. 2 and electrical connections (not shown), the circuit board 22 has a plug-connector element 42 for power supply of the circuit board as well as electronic and/or electric components 44 that serve for operating and/or coding of the circuit board 22 and semiconductor-light sources that are mounted onto the circuit board 22.

The components 44 could be, e.g., a control unit coding resistors, and/or electronic devices for coding the circuit board 22 and/or sensors—in particular, temperature sensors (e.g., an “NTC” or a “PTC” resistor). Instead of one circuit board, several circuit boards could he used.

For each of the “n”=10 semiconductor-light sources, there is exactly one optical lens. In line with this, the first row 18 of semiconductor-light sources is assigned to a first row 26 of optical lenses. Each, semiconductor-light source 18.1, 18,2, 18.3, 18.4, 18.5 of the first row 18 of semiconductor-light sources is assigned to one optical lens 26.1, 26.2, 26.3, 26.4, 26.5 of the first row 26 of optical lenses. The second row 20 of semiconductor-light sources is assigned to a second row 28 of optical lenses. Each semiconductor-light source 20.1, 20.2, 20.3, 20.4, 20.5 of the first row 20 of semiconductor-light sources is assigned to one optical lens 28.1, 28.2. 28.3, 28.4, 28.5 of the second row 28 of optical lenses.

Each optical lens bundles and focuses the light emitting from the semiconductor-light source to which it is assigned. As can be seen in FIG. 2, the light apertures of the optical lenses point in different directions. This shows that the light from the semiconductor-light sources is not focused onto one single point. But, rather, already the light distribution of the optical lenses inside the light module 12 shows to have different spatial sections into which light of each semiconductor-light source is being focused and directed.

This inner light distribution with its different sections is projected into the front am of the headlight 10 by the projection lens 32 so that the light distribution that finally results on the road is made-up of different sections location of which within the light distribution is dependent on the location and direction on the associated pair of semiconductor-light source and optical lens inside the light module 12.

The individual optical lenses are, in an embodiment, part of a single-piece optical-lens carrier 46. Such a single-piece optical-lens carrier 46 can be produced, e.g., by injection-molding of a translucent plastic material—like PMMA (polymethylmethacrylate), PC (polycarbonate), glass, or another translucent material. The use of single-piece optical-lens carriers 46 has the special advantage that the respective position and direction of the individual optical lenses of the optical lens carrier 46 are unchangeably fixed toward each other so that there is no need for extensive adjusting steps for the adjustment of the individual optical lenses when the light module 12 is assembled. The optical-lens carrier 46 is, e.g., screwed to the cooling element 24, whereby the circuit board 22 is fixed between the optical-lens carrier 46 and cooling element 24. This also leads to a particularly good thermal contact between the circuit board 22 and contact surface of the cooling element 24. The thermal contact can be increased by using heat-conducting paste or glue between the contact surface and circuit board 22.

The Individual semiconductor-light sources are, in an embodiment, connected to the power supply on the circuit board 22 in such a way that they can be operated individually or in groups so that semiconductor-light sources can be switched “on” or “off” or dimmed individually or in groups.

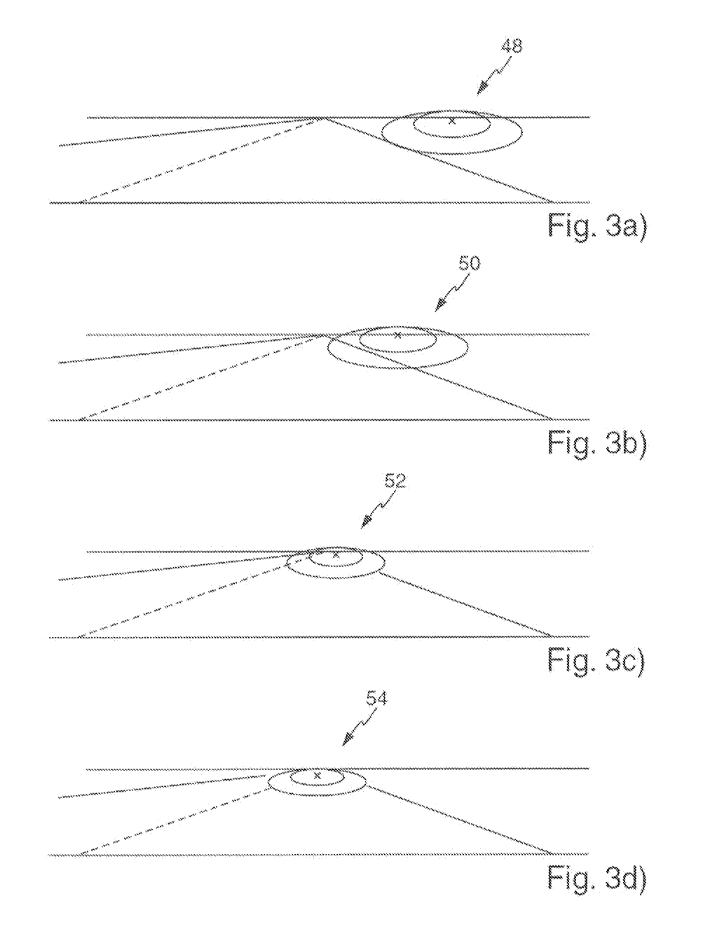

FIG. 3 displays different sections of a light distribution as the headlight 10 produces them into its front area or, especially, onto the road from the vehicle. Hereby, only one respective section is displayed as it is produced by one semiconductor-light source or a group of semiconductor-light sources that are switched or operated together. The displayed sections are not used individually during normal operation of a motor vehicle, but merely serve to visualize the technical operation of the invention. The normal light distribution used during operation of a vehicle is, in particular, a result of all displayed sections being used at the same time.

In FIG. 3, a total of four sections 48, 50, 52, 54 are displayed qualitatively. Each section represents a light distribution in itself. The cross inside each section marks the individual center point of such a light distribution in which the maximal brightness is achieved. The two closed curves surrounding the cross that do not cross-cut each other represent respective “isolux” curves (or lines) that connect geometrical areas of the same brightness (inside the loop). Hereby, the brightness decreases from the inside toward the outside—in other words, from the cross passing the middle curve toward the outer curve.

Section 48 displayed in FIG. 3a is produced by the outer semiconductor-light source—in particular, the semiconductor-light source 18.5 in connection with optical lens 26.5 that is assigned to the semiconductor-light source 18.5. The “light technical” function of this section 48 consists of producing a gradual transition from the dark area on the right side of the section 48 toward the brighter central area of an actually used light distribution.

Section 50 from FIG. 3b is produced by the semiconductor-light source 18.4 and optical lens 26.4 assigned to this semiconductor-light source and serves as a connection of the section 48 from FIG. 3a toward a more central, brightly illuminated area of a real light distribution.

Section 52 from FIG. 3c is produced by the central semiconductor-light source 18.3 and optical lens 26.3 assigned to this central semiconductor-light source. The “light technical” function of section 26.3 consists of illuminating the central-front area of the headlight 10 with the longest range possible.

Section 54 from FIG. 3d serves to produce a maximal illumination in the center of a real light distribution that is to be produced and is produced by central semiconductor-light sources and optical lenses—in particular, the semiconductor-light source 20.2 in connection with its optical lens 20.2 and/or semiconductor-light source 20.3 in connection with its optical lens 26.3.

In comparison to section 52, section 54 is positioned a little lower so that section 52 marks the cut-off line while section 54 provides the maximal illumination for the area below the cut-off line in the center of the light distribution.

The individual sections of the light distribution (e.g., sections 48, 50, 52, 54 as well as the remaining sections that are produced by the other remaining pairs of semiconductor-light sources and optical lenses) result all together in a rule-consistent spatial light distribution in the front area of the headlight. As has been described herein, the headlight 10 concerns a headlight for a motor vehicle that consists of at least two semiconductor-light sources and light-refracting and/or light-reflecting optics that are arranged and positioned to direct light of at least two semiconductor-light sources into the from area of the headlight 10 in such a way that it produces a rule-consistent spatial light distribution there.

The light-refracting and/or light-reflecting optics consist of, in particular, the optical lenses, panel and secondary lens. The panel here is light-reflecting optics. A projection lens is mere light-refracting optics. And, the optical lenses are, depending on the model, either light-refracting optics in a form of lenses or light-refracting and a light reflector in a form of TIR-optical lenses (TIR=total internal reflection).

As shown in FIG. 3, with the different sections 48, 50, 52, 54, the semiconductor-light sources and optics are arranged in such a way that an illuminated section of the light distribution produced by a first of at least two semiconductor-light sources is not identical with an illuminated section of the light distribution produced by a second of at least two semiconductor-light sources. In FIG. 3, for example, none of the four sections 48, 50, 52, 54 is identical to another one of the four sections.

For producing light distributions for headlights 10 of motor vehicles, semiconductor-light sources of various “construction” types and with various characteristics are available. These semiconductor-light sources with various characteristics can be roughly divided into three “construction” types—“A,” “B,” and “C”—that differ, particularly, by their values of luminous flux produced and, thereby, efficiency achieved.

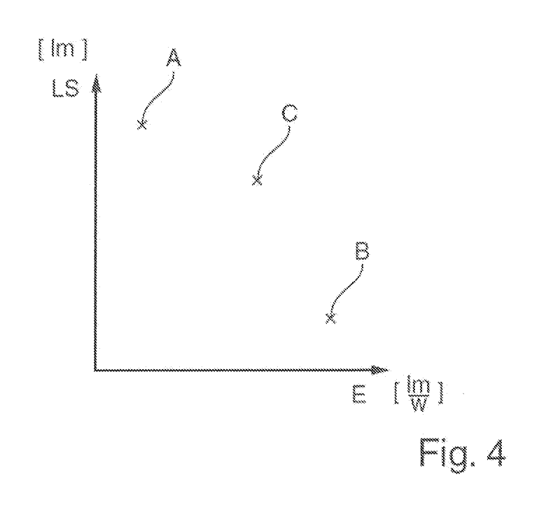

FIG. 4 displays a diagram in which luminous fluxes are recorded in relation to their efficiency. Hereby, the luminous flux is given in lumens (lm), and the efficiency is given in lumens per watt (lm/W). FIG. 4 displays pairs of values of three different semiconductor-light source “construction” types. These three “construction” types are differentiated from each other by “A,” “B,” and “C.”

Semiconductor-light sources of “A” are characterized by a high maximal luminous flux. But, they have rather lower efficiency in comparison with other semiconductor-light sources.

Semiconductor-light sources of “B” are characterized by a high efficiency that is, in particular, higher than the efficiency of semiconductor-light sources of “A.” Yet, luminous flux of semiconductor-light sources of “B” is rather low—in particular, lower than the maximal luminous flux of the semiconductor-light sources of “A.”

Semiconductor-light sources of “C” are characterized in that their maximal luminous flux consists of an average value that is between the maximal luminous flux of semiconductor-light sources of “A” and “B.” Semiconductor-light sources of “C” are further characterised in that their efficiency is also located between the efficiency values of the semiconductor-light sources of “B” and “A.”

Typical representatives of “A” are, e.g., light-emitting diodes that are pre-assembled on a carrier unit, whereas further devices are also integrated into that carrier unit—like electronic contacting, temperature sensors, and coding resistors. In addition to this, such a carrier unit generally serves for attaching the unit to its technical surrounding (e.g., a circuit board 22). A circuit board 22 is understood to be any technical equipment that carries several semiconductor-light sources and associated power-supply and control circuits. Representatives of “A,” are “Philips Lumileds Altilon” light-emitting diodes and “Osram Ostar” headlamp light-emitting diodes. These light-emitting diodes are electronically and thermally designed for a current-carrying capacity that ranges between 1 and 2.5 amperes. In this way, a luminous flux of about 250 lumens per square millimeter of chip space can be achieved. The luminance amounts to 6×107 candelas per square meter. The so-called “wall-plug efficiency,” which refers to the luminous flux in relation to the energy absorbed, amounts to approximately 75 lumens per watt. Light-emitting-diode chips of the size of one square millimeter are available as arrays of various sizes that are combined mechanically or electrically so that powerful light sources can be produced. Examples of combinations are light-emitting-diode arrangements with 1×2, 1×3, 1×4, 1×5, 1×6, 2×2, etc.

Semiconductor-light sources of “B” result from molded one-chip light-emitting diodes. These are light-emitting diodes that are arranged onto a ceramic carrier or so-called “lead-frame package” (generally a molded metal frame) and designed to be attached and contacted by a soldering process—in particular, “surface-mounted device” (SMD) soldering. “B” is represented by light-emitting diodes of “Osram Oslon” and “Philips Rebel.” Semiconductor-light sources of “B” are characterized in that they are covered with an almost hemispherical molding for protection and a better output efficiency. The hemispherical molding generally consists of optical silicone. The light-emitting diodes are designed for an electronically and thermally current-carrying capacity of up to approximately one ampere. The molding increases not only the output efficiency, but also the light-emitting-diode chip area by a factor of two (just like a magnifier). Nowadays, such light-emitting diodes with a chip area of one square millimeter or two square millimeters are available on the market. Typical luminous fluxes of semiconductor-light sources of such “construction” types amount to 150 lumens at a current of 350 milliamperes. The luminance amounts to 2×107 candelas per square meter and, thereby, reaches 30% of the corresponding reference value of semiconductor-light sources of “A.” The wall-plug efficiency amounts to approximately 100 lumens per watt.

Semiconductor-light sources of “C” are generally one-chip light-emitting diodes that are arranged onto a ceramic carrier or so-called “lead-frame package” (generally a molded metal frame) and designed to be attached and contacted by a soldering process. Also here, in an embodiment, “SMD” soldering is the soldering process. A representative of “C” is the light-emitting diode “Nichia NJSW072T.” Light-emitting diodes of this “construction” type are characterized in that they are designed for an electronic and thermal current-carrying capacity of about one ampere. There is no optical molding. For this reason, such light-emitting diodes are less efficient in connection with light-output efficiency than light-emitting diodes of “B,” but they have the advantage of having the same luminance as the high-power arrays made of semiconductor-light sources of “A.” In a certain way, “C” forms a link between “A” and “B.”

The invention uses the different characteristics of the semiconductor-light sources of various “construction” types. The non-identity of the various sections seen in FIG. 3 already results from the spatial separation of the semiconductor-light sources, which, for their part, inevitably calls for the use of several semiconductor-light sources. Individual semiconductor-light sources illuminate certain sections of the light distribution via individual optical lenses. Certain partial functions can be assigned to these sections, like the production of a maximum range or soft transition toward the darker side section. This leads to the possibility to influence these individual partial functions—in other words, illumination of the various sections (by not only the respective optical lens, but also using semiconductor-light sources of various “construction” types in one and the same light module 12.

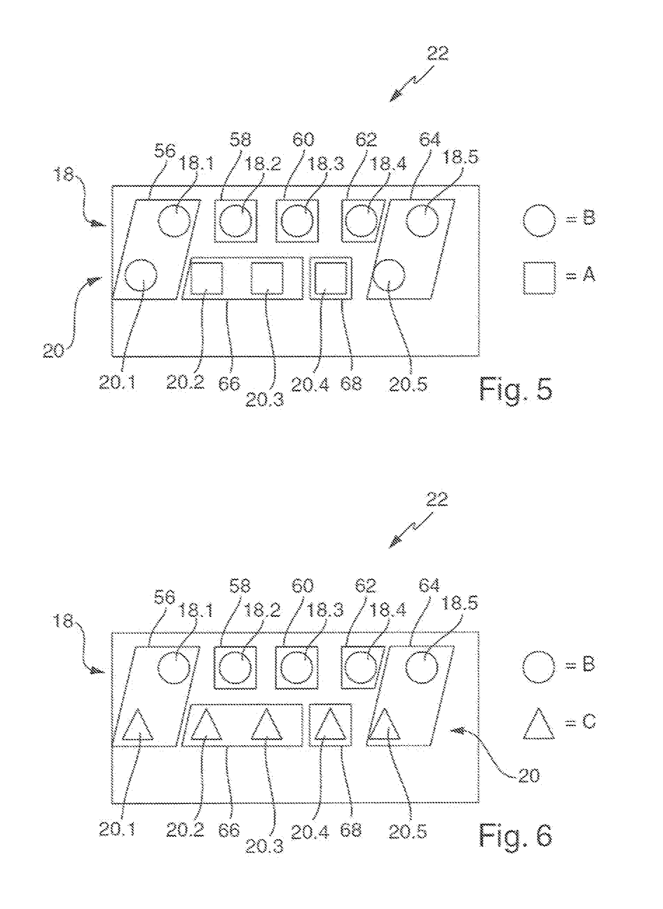

Referring to FIGS. 5 to 7, this is further expounded. FIGS. 5 to 7 show an arrangement of “N”=10 semiconductor-light sources on a circuit board 22. As already explained in connection with FIG. 2, the semiconductor-light sources here are arranged in a first row 18 and second row 20. In the embodiment displayed in FIG. 5, the semiconductor-light sources are additionally divided into seven different groups, whereby each group fulfills a “light” function in that it illuminates a certain section (like a section that is displayed in FIG. 3).

A first group 56 consists of the semiconductor-light sources 18.1, 20.1 and serves to illuminate a section on the left side. A second group 58 consists of the individual semiconductor-light source 18.2 and serves to illuminate a left-front area. A third group consists of the individual semiconductor-light source 18.3 and serves to illuminate a central-front area. A fourth group consists of the individual semiconductor-light source 18.4 and serves to illuminate a right-front area. A fifth group 64 consists of the semiconductor-light sources 18.5, 20.5 and serves to illuminate a right-side section. A sixth group consists of the semiconductor-light sources 20.2, 20.3 and serves to produce a maximum luminous intensity in the center of the light distribution. A seventh group consists of the individual semiconductor-light source 20.4 and serves to produce the gradient of the asymmetrical light distribution of a low-beam light distribution.

For the different groups, different “construction” types of semiconductor-light sources are used. In the embodiment displayed in FIG. 5, semiconductor-light sources of “B” are used for the first group 56, second group 58, third group 60, fourth group 62, and fifth group 64 that are characterised by high energy efficiency, but, therefore, consist of comparatively low luminous flux and luminance. On the other hand, semiconductor-light sources of “A” are used for the sixth group 66 and seventh group 68 that do have lower energy efficiency, but supply high luminance and luminous flux. The circuit board 22 in FIG. 5, assembled in this way, is, thus, particularly suited for producing light distributions with high maximum value in the center of the light distribution. Since the peripheral sections of the light distribution (being made-up of the first group 56, second group 58, third group 60, fourth group 62, and fifth group 64) are Illuminated by semiconductor-light sources, the total energy efficiency of the arrangement is still acceptable using semiconductor-light sources with higher efficiency (despite the high maximum value of brightness in the center of the light distribution).

Thus, FIG. 5, in particular, shows an embodiment in which semiconductor-light sources of a first “construction” type and second “construction” type are used, whereby the first and second “construction” types differ in that semiconductor-light sources of the first “construction” type consist of higher luminous flux and lower efficiency in comparison to semiconductor-light sources of the second “construction” type. In the embodiment displayed in FIG. 5, the first “construction” type corresponds to “A,” and the second “construction” type corresponds to “B.”

FIG. 6 displays a circuit board 22 where the first row 18 of semiconductor-light sources 18.1, 18.2, 18.3, 18.4, 18.5 is equipped with semiconductor-light sources of “B” while the second row 20 of semiconductor-light sources is equipped with semiconductor-light sources of “C.” The semiconductor-light sources of “B” are characterized by comparatively high energy efficiency along with lower luminance and luminous flux whereas the semiconductor-light sources of “C” are characterised by average energy efficiency, high luminance, and an average value of luminous flux. In this embodiment, semiconductor-light sources of “C” represent exponents of the first “construction” type while semiconductor-light sources of “B” represent exponents of the second “construction” type. Then, the same holds true that the first and second “construction” types differ in that semiconductor-light sources of the first “construction” type consist of higher luminous flux and lower efficiency in comparison to semiconductor-light sources of the second “construction” type. Circuit board 22, according to FIG. 6, is well suited for producing light distributions with average values of the maximum, value of brightness in the center of the light distribution, whereby the efficiency of the arrangement is guaranteed, in particular, by the use of light-emitting diodes of “B” with high energy efficiency in the upper row 18.

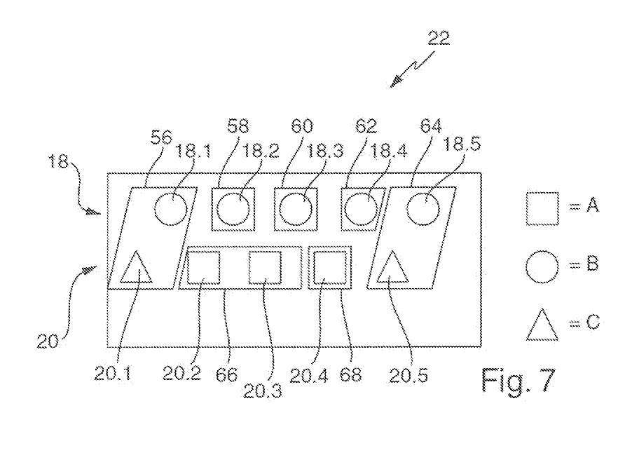

FIG. 7 displays a circuit board 22 with a first row 18 of semiconductor-light sources equipped with semiconductor-light sources of “B.” The group 56, assigned for illuminating the left side, features (next to a semiconductor-light source of “B” in the first row 18) a semiconductor-light source of “C” in the second row 20. The same holds true for the fifth group that illuminates a section of the light distribution on the right side. In this way, the placement on circuit hoard 22 in FIG. 7 corresponds to the placement on circuit board 22 in FIG. 6. Yet, a difference of the circuit board of FIG. 7 toward the circuit hoard of FIG. 6 results in the central areas 66, 68, with which the maximum brightness is produced and the gradient of the asymmetrical light distribution of a low-beam light is illuminated. While these groups 66, 68 are equipped with semiconductor-light sources of “C” in the case of FIG. 6, they are equipped with semiconductor-light sources of “A” in the case of FIG. 7. Since semiconductor-light sources of “A” supply a particularly high luminous flux, the circuit board according to FIG. 7 is especially suited for light distributions with high maximum values of brightness in the central area along with good illumination on the sides (a light source of “C”) and an energy-optimized front area (five light sources of “B”).

The invention provides a motor-vehicle headlight with which it is possible to achieve high-energy efficiency without having to deal with major restrictions.

The invention has been described above In an illustrative manner. It is to be understood that the terminology that has been used above is intended to be in the nature of words of description rather than of limitation. Many modifications and variations of the invention are possible in light of the above teachings. Therefore, within the scope of the appended claims, the invention may be practiced other than as specifically described above.

What is claimed is:

1. A headlight for a motor vehicle, the headlight comprising:
at least two semiconductor-light sources; and
at least one of a plurality of light refractors and reflecting optics, wherein light of each of the semiconductor-light sources is directed into a front area of the headlight such that the light produces at the front area a rule-consistent light distribution, an illuminated section of the light distribution of a first of the semiconductor-light sources is not identical with an illuminated section of a second of the semiconductor-light sources, the first semiconductor-light source defines a first construction type and the second semiconductor-light source defines a second construction type, and the first construction type defines higher luminous flux and lower efficiency relative to luminous flux and efficiency defined by the second construction type.

2. The headlight as set forth in claim 1, wherein sections with higher demands of the luminous flux are illuminated by more highly luminous-flux emitting ones of the semiconductor-light sources.

3. The headlight as set forth in claim 1, wherein sections with lower demands of the luminous flux are illuminated by more highly efficient ones of the semiconductor-light sources.

4. The headlight as set forth in claim 1, wherein a common cooling element is used for the semiconductor-light sources of a light module.

5. The headlight as set forth in claim 1, wherein each of a plurality of optical lenses is part of a single-piece optical-lens carrier.

6. The headlight as set forth in claim 5, wherein the optics for each of a plurality of the semiconductor-light sources includes the optical lens and a common secondary lens, the optical lens focuses the light of the semiconductor-light source and directs the light onto the secondary lens either of directly and indirectly, and the incoming light is directed into the front area of the headlight.

7. The headlight as set forth in claim 5, wherein the optical lenses are either of light-bundling TIR-optics and ancillary lenses.

8. The headlight as set forth in claim 6, wherein the optics includes a panel.

9. The headlight as set forth in claim 6, wherein the panel is mirrored to reflect the incoming light of the semiconductor-light sources on the panel toward the secondary lens.

10. The headlight as set forth in claim 1, wherein the light distribution in the front area of the headlight defines a central section and a plurality of peripheral sections surrounding the central section and the central section is illuminated by at least one of the semiconductor-light sources of the first construction type.

11. The headlight as set forth in claim 10, wherein at least one of the peripheral sections is illuminated by at least one of the semiconductor-light sources of the second construction type.

12. The headlight as set forth in claim 1, wherein the light distribution defines a plurality of peripheral sections, left-side illuminating area, left front-section area, central front-section area, right front-section area, right-side illuminating area, central maximum area, and central gradient area.

13. The headlight as set forth in claim 12, wherein each of the left-side illuminating area, right-side illuminating area, and central, maximum area is illuminated by two of the semiconductor-light sources and each of the remaining sections and areas is illuminated with one of the semiconductor-light sources.

14. The headlight as set forth in claim 13, wherein the central maximum area is illuminated by two of the semiconductor-light sources of the first construction type.

15. The headlight as set forth in claim 13, wherein each of the left-side illuminating area and right-side illuminating area is illuminated by either of two of the semiconductor-light sources of the second construction type and one of the semiconductor-light sources of the first construction type and one of the semiconductor-light sources of the second construction type.

16. The headlight as set forth in claim 12, wherein the central gradient area of an asymmetrical light distribution is illuminated by one of the semiconductor-light sources of the first construction type.
